(19) United States
(12) Patent Application Publication
(10) Pub. No.: US 2003/0036405 A1
(43) Pub. Date: Feb. 20, 2003

(54) Cellular phone

(75) Inventor: Kazuyoshi Hijii, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/210,047

(22) Filed: Aug. 2, 2002

(30) Foreign Application Priority Data
Aug. 15, 2001 (JP) 246636/2001

(51) Int. Cl. H04B 1/00

(52) U.S. Cl. 455/552; 455/553

(57) ABSTRACT

The present invention discloses a cellular phone provided with a drive mode, which includes means for selecting the drive mode and executing the drive mode, means for setting end time of the drive mode when the drive mode is executed, means for transmitting information of the drive mode setting and information of the end time to a service center, means for notifying approaching to the end time before the end time by a predetermined time by an alarm, means for resetting end time of the drive mode when the drive mode is executed, and means for retransmitting information of the reset end time to the service center.

### BACKGROUND OF THE INVENTION

1. Field of the Invention

The present invention relates to a portable terminal and a cellular phone for executing a drive mode. The drive mode is designed to notify a caller of an impossibility of answering a call by a receiver because he is in the middle of driving.

2. Description of Related Art

In cellular phones used in Japan and employing, for example, a personal digital cellular (PDC) system or the like, there is available a mode called a driving guidance function (referred to as a drive mode, hereinafter). As a receiver is in the middle of driving when he receives a call on this drive mode, a message of not off-hooking is given to a caller through service center exclusive guidance at a provider side. Setting/releasing of the drive mode is carried out by a user as a receiver, who operates a switch of the cellular phone. Specifically, the user requests execution or stopping of execution of the drive mode to the service center by, for example, pushing one specific button switch or dialing a predetermined number, thereby enabling the drive mode to be executed or its execution to be stopped.

Japanese Unexamined Patent Publication No. 2000-032563 (laid-open: Jan. 28, 2000) describes a telephone, which enables a user having set a mode such as a drive mode in his cellular phone to set releasing time in order to prevent forgetting to release the set mode, and automatically releases the mode at the releasing time.

Japanese Unexamined Patent Publication No. 200-0188781 (laid-open: Jul. 4, 2000) describes a cellular phone, which automatically sets/releases a manner mode therein based on ID information from a base station, and automatically sends a message of not being able to answer during the manner mode.

Japanese Unexamined Patent Publication No. 2000-209310 (laid-open: Jul. 28, 2000) describes a cellular phone, which includes a mode end timer, and executes a voice notification function including time until the mode end when an incoming call cannot be answered during a manner mode.

A first problem inherent in the above conventional technologies was that on the mode inhibiting an incoming call to be answered, a date and time of calling-back was allowed to be notified only at the arrival time of a call.

A second problem was that when a scheduled date and time of mode changing was changed, a message thereof was not allowed to be given to a caller while the mode was set.

The present invention was made with the foregoing problems in mind, and it is an object of the invention to provide a cellular phone, which enables a message thereof to be given to a caller during mode execution when scheduled time of mode changing is changed.

### SUMMARY OF THE INVENTION

In accordance with a first aspect of the present invention, a cellular phone for executing a drive mode is provided, which includes means for selecting the drive mode and transferring to the drive mode, means for setting a first end time of the drive mode while the drive mode is set, means for transmitting information of the drive mode setting and information of the first end time to a service center, means for notifying approaching to the first end time before the end time by a predetermined time by an alarm, means for setting the second end time of the drive mode again while when the drive mode is executed, and means for retransmitting information of set the second end time to the service center.

The cellular phone may further include means for automatically notifying current execution of the drive mode and the end time of the drive mode by voice to a caller when a call comes in during execution of the drive mode, means for extending the end time per one predetermined time unit by repeating the means of setting the drive mode in the means for resetting the end time of the drive mode, and means for automatically notifying current execution of the drive mode and end time of the drive mode by voice for each resetting to a caller who makes a call while the drive mode is set, when the end time of the drive mode is reset by the extending means.

In accordance with a second aspect of the present invention, a drive mode setting method in a cellular phone for executing a drive mode is provided, which includes the steps of selecting the drive mode and executing the drive mode, setting a first end time of the drive mode while the drive mode is executed, transmitting information of the drive mode setting and information of the first end time to a service center, notifying approaching to the end time before the end time by a predetermined time by an alarm, setting a second end time of the drive mode while the drive mode is executed, and retransmitting information of the second end time to the service center.

In accordance with a third aspect of the present invention, a program is provided for causing a computer to carry out a drive mode setting method in a cellular phone for executing a drive mode, the method comprising the steps of, selecting the drive mode and executing the drive mode, setting a first end time of the drive mode while the drive mode is executed, transmitting information of the drive mode setting and information of the first end time to a service center, notifying approaching to the first end time before the end time by a predetermined time by an alarm, setting a second end time of the drive mode while the drive mode is executed, and retransmitting information of the second end time to the service center.

### BRIEF DESCRIPTION OF THE DRAWINGS

The above and other objects, features and advantages of the present invention will become more apparent from the following detailed description when taken in conjunction with the accompanying drawings wherein:

FIG. 1 is a view showing a relation between a cellular phone and a service center;

FIG. 2 is a functional view schematically showing a functional configuration of a cellular phone of the present invention;

FIG. 3 is a flowchart showing an operation example of setting a drive mode and time according to a first embodiment of the present invention; and

FIG. 4 is a flowchart showing an operation example of resetting set time in the first embodiment of the present invention.

### DETAILED DESCRIPTION OF THE PREFERRED EMBODIMENTS

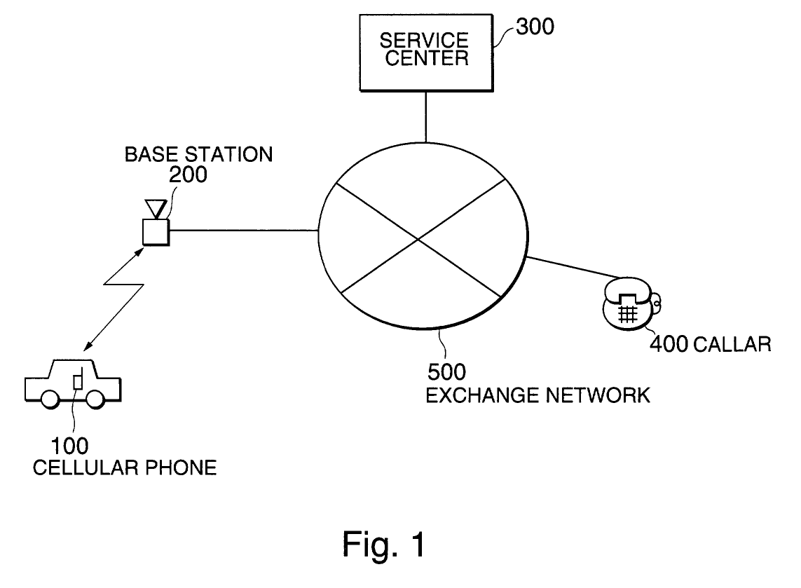

Now, description will be made of relation between a service center and a cellular phone network when cellular phone is sets in drive mode by referring to FIG. 1.

The drive mode is designed to notify a caller of an impossibility of answering a call by a receiver because he is in the middle of driving.

A service center 300, caller 400 and a base station 200 are connected with an exchange network 500. When caller calls a driver's cellular phone, call is connected automatically to service center 300 for answering a message.

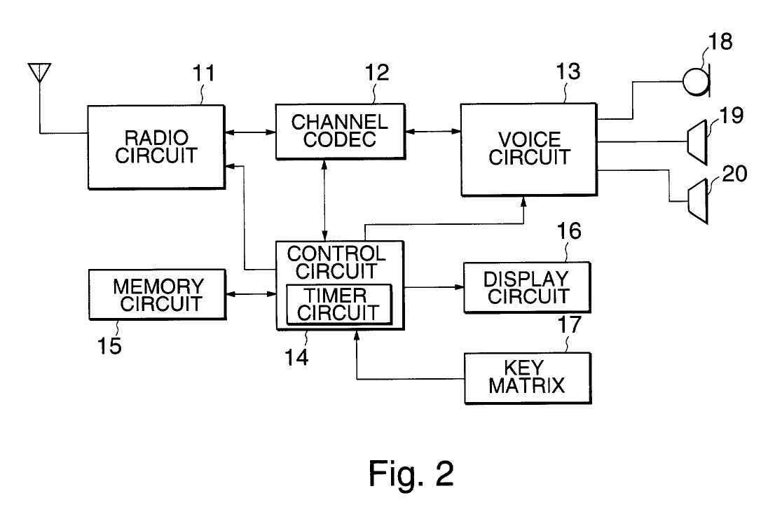

FIG. 2 shows a block diagram of a cellular phone, referring to a first embodiment of the present invention.

The cellular phone includes a radio circuit 11, a channel codec 12, a control circuit 14, a voice circuit 13, a memory circuit 15, a display circuit 16, a key matrix 17, a microphone 18, a receiver 19 and a speaker 20.

A key for setting a drive mode is normally located in the key matrix 17, and the drive mode is set by pressing this key long.

The key matrix 17 is provided for selecting the drive mode. The control circuit 14 executes the drive mode. And the key matrix 17 sets an end time of the drive mode while the drive mode is executed. The contol circuit 14 detects approaching to the end time before the end time by a predetermined time by generating an alarm. The radio circuit 11 transmites/retransmites information of the drive mode setting and information of the end time to a service center 300.

The service center 300 notifies the drive mode and the first end time of the drive mode by voice to a caller when a call comes in during execution of the drive mode. The control circuit 14 extends the end time per one predetermined time unit by setting the second end time of the drive mode. The service center 300 notifies the drive mode and end time of the drive mode by voice for each setting to a caller who makes a call during execution of the drive mode, when the second end time of the drive mode is set.

As a method of entering the drive mode, a method of sharing information indicating setting of the drive mode between a portable terminal and a service center, a method of entering the drive mode only by the portable terminal, are available.

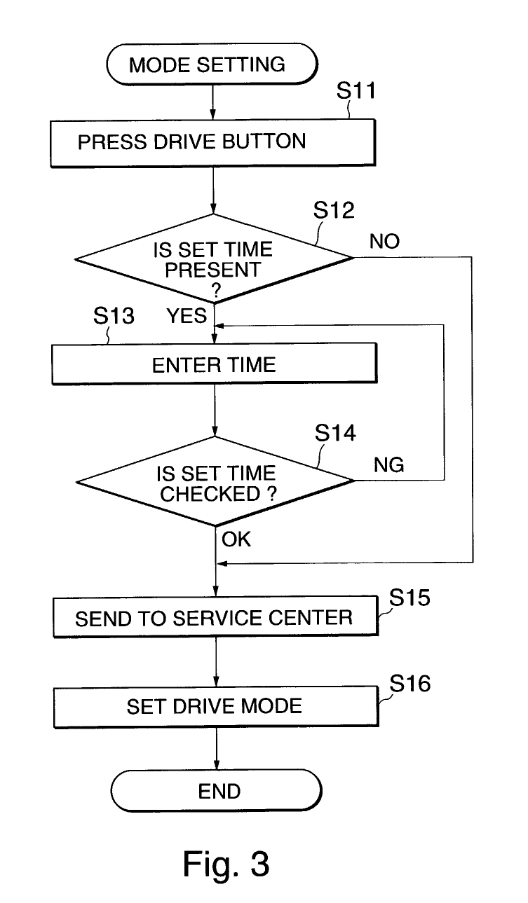

The first embodiment of the invention is directed to the method of sharing information indicating setting of the drive mode between the portable terminal and the service center. This method is now described by referring to FIG. 3 as a flowchart of a drive mode setting process.

First, a time setting screen of the drive mode is displayed by the display curcuit 16 after an user presses, a drive mode key located in the key matrix 17 (S11).

Here, selection is made by the key matrix 17 as to whether a time (first end time) for ending the drive mode is set or not (S12). When the set time is not set, setting information of a drive mode is immediately transmitted to the service center (S15) through the radio circuit 11 under the control of the control circuit 14.

When the set time of ending the drive mode is set, the set time is entered (S13), and then the set time is checked (S14) by the control circuit 14. Then, by pressing a check key on the key matrix 17, the drive mode and the set time (first end time) are sent to the service center 30 from the radio circuit 11(S15).

Upon having received the set time, the service center 300 automatically counts down the time, and announces a message of the drive mode and expected end time of the drive mode (end after how many minuets or at what time) to a caller who has made a call to the cellular phone 100 in which the drive mode is executed.

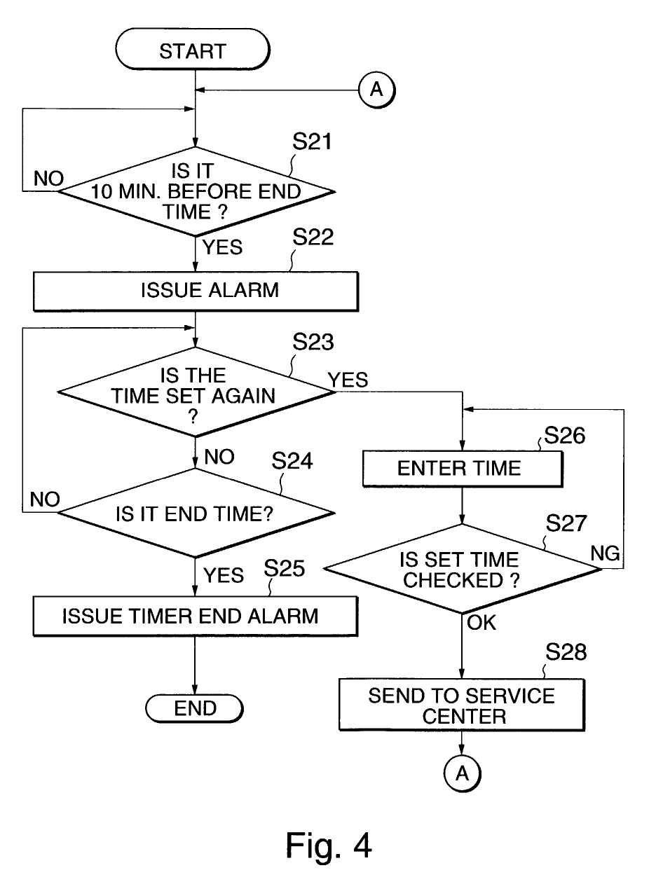

FIG. 4 is a flowchart showing a process of setting time again. Now, setting of time (setting a second end time) is described by referring to this flowchart.

In a state where the set time (first end time) of the drive mode approaches its end, at 10 minutes before the end of the drive mode (S21), the control circuit 14 of the cellular phone 100 in which the drive mode is executed issues an alarm (S22) and notifies the approaching to the set time.

At this time, the user can set the second end time (S23) by the key matrix 17 (S26), and the user presses the check key (S27), and thereby the second end time is transmitted to the service center (S28).

By repeating this process, the drive mode can be extended.

Next, description will be made of a second embodiment of the present invention.

In the first embodiment of the invention, the set time is shared between the portable terminal and the service center. However, the drive mode can be executed only by the portable terminal. In the case of setting the drive mode only by the portable terminal, when a call comes into the portable terminal, the call is received by the portable terminal without any ringtones, and a message of the drive mode is announced to the caller. At this time, the portable terminal can automatically answer and record the call.

In addition, the set time of the drive mode can be extended for 30 min., by each clicking of the drive mode key as well as by using 10 keys. Accordingly, the set time can be easily extended even during driving, and a message of each changing of drive mode end time is automatically given by voice to a caller who makes a call while the drive mode is set.

A first advantage of the present invention is that drive mode end time can be notified by a voice message to a caller who makes a call to the cellular phone set to the drive mode.

A second advantage of the present invention is that since time until calling again is known, it is not necessary to call back many times.

A third advantage of the present invention is that the approaching of the drive mode to its set end time is notified by an alarm, and it is thereby possible to eliminate forgetting to reset time and forgetting to release the drive mode.

A fourth advantage of the present invention is that for each changing of the drive mode end time necessitated because of congestion or the like, the drive mode end time can be notified by a voice message to a caller who makes a call on the drive mode.

While this invention has been described in connection with certain preferred embodiments, it is to be understood that the subject matter encompassed by way of this invention is not to be limited to those specific embodiments. On the contrary, it is intended for the subject matter of the invention to include all alternatives, modifications and equivalents as can be included with the spirit and scope of the following claims.

What is claimed is:

1. A cellular phone provided with a drive mode, comprising:
means for selecting the drive mode and executing the drive mode;
means for setting a first end time of the drive mode while the drive mode is executed;
means for transmitting information of the drive mode setting and information of the first end time to a service center;
means for notifying approaching to the end time before the end time by a predetermined time by an alarm;
means for setting a second end time of the drive mode while the drive mode is executed; and
means for retransmitting information of the second set end time to the service center.

2. The cellular phone according to claim 1, further comprising:
means for notifying being in the drive mode and the first end time of the drive mode by voice to a caller when a call comes in during execution of the drive mode;
means for extending the end time per one predetermined time unit by setting the second end time of the drive mode; and
means for notifying being in the drive mode and end time of the drive mode by voice for each setting to a caller who makes a call during execution of the drive mode, when the second end time of the drive mode is set by the extending means.

3. A drive mode setting method in a cellular phone provided with a drive mode, comprising the steps of:
selecting the drive mode and executing the drive mode;
setting a first end time of the drive mode while the drive mode is executed;
transmitting information of the drive mode setting and information of the first end time to a service center;
notifying approaching to the end time before the end time by a predetermined time by an alarm;
setting a second end time of the drive mode while the drive mode is executed; and
retransmitting information of the second end time to the service center when the setting is executed.

4. The drive mode setting method according to claim 3, further comprising the steps of:
selecting the drive mode and executing the drive mode;
setting a first end time of the drive mode while the drive mode is executed;
transmitting information of the drive mode setting and information of the end time to the service center;
notifying approaching to the end time before the end time by a predetermined time by an alarm;
setting a second end time of the drive mode while the drive mode is executed; and
retransmitting information of the second end time to the service center.

5. A program for causing a computer to carry out a drive mode setting method in a cellular phone provided with a drive mode, the method comprising the steps of:
selecting the drive mode and executing the drive mode;
setting a first end time of the drive mode while the drive mode is set;
transmitting information of the drive mode setting and information of the first end time to a service center;
notifying approaching to the end time before the end time by a predetermined time by an alarm;
setting a second end time of the drive mode while the drive mode is executed; and
retransmitting information of the second end time to the service center.

6. The program according to claim 5, wherein the drive mode setting method further comprising the steps of:
selecting the drive mode and executing the drive mode;
setting a first end time of the drive mode while the drive mode is executed;
transmitting information of the drive mode setting and information of the first end time to the service center;
notifying approaching to the end time before the end time by a predetermined time by an alarm;
setting a second end time of the drive mode while the drive mode is executed; and
retransmitting information of the second end time to the service center.
